(19) United States
(12) Patent Application Publication
(10) Pub. No.: US 2003/0023627 A1
(43) Pub. Date: Jan. 30, 2003

(54) System and method for indicating a measure of content copy fitting

(76) Inventor: John M. Kerr, Monmouth, OR (US)

Correspondence Address: HEWLETT-PACKARD COMPANY, Intellectual Property Administration, P.O. Box 272400, Fort Collins, CO, 80527-2400, US

(21) Appl. No.: 09/917,012

(22) Filed: Jul. 26, 2001

(51) Int. Cl. G06F 15/00

(52) U.S. Cl. 707/507; 707/517

(57) ABSTRACT

A method is provided for indicating a measure of a text fill copy fitting for a portion of text in a document. In this regard, the method comprises the steps of detecting a change in a text fill inputted into a text fill box in a computer system, measuring a length of the text fill, performing a comparison between the length of the text fill with at least one predetermined length threshold, and, indicating a compatibility of the text fill with an associated text portion of a document based on the comparison, the associated text portion incorporating the text fill.

### TECHNICAL FIELD

The present invention is generally related to the field of document processing and, more particularly, is related to a system and method for indicating a measure of content copy fitting for a portion of a document.

### BACKGROUND OF THE INVENTION

In the mid 1400's, Johann Gutenberg revolutionized how information is disseminated through his invention of the movable type press. With the publication of the Mazarin Bible, documents that were once held in the exclusive domain of a chosen few were now widely available to the masses. Nearly 550 years later, the mass media revolution that Gutenburg started is alive and well, complete with newspapers such as the New York Times and the Washington Post, magazines such as Newsweek and Sports Illustrated, and literally thousands upon thousands of other lesser known publications.

Since Johann Gutenberg introduced the first movable type press, individuals have had a place to go to print special documents for particular purposes. For example, an individual may wish to print up flyers that announce the date and time of a party or other event. In the past, such a person might engage the services of a printer who could create the flyers for a fee. Also, an individual might create a single flyer using a word processor and then go to a printer to copy the flyer multiple times for posting in various locations.

While these approaches provide an ability to print multiple copies of documents for various purposes, they are not without problems. Specifically, many types of printed documents are more effective in the way they relay information to people if they are in a specific format. Specifically, the content and layout of document effects the way it is perceived by individual. Thus, a document may be more effective in communicating to people if the content and layout are properly configured. This implies that a certain amount of research into the most effective layouts of a document should be performed before creating a document. Unfortunately, not everyone has the time or the expertise to determine the precise layout that communicates a message most effectively.

One solution to this problem is a networked based application for creating documents. Such an application may allow the creation of a document based on templates that employ layouts that have been researched for effective communication. With such applications, the layout may be predefined based on research as to communication effectiveness. Specifically, the predefined layouts may comprise a number of preset regions on a page. A user would enter text fill or images that are placed within such regions. Unfortunately, the average individual may not adhere to the requirements of length and detail of the content entered in such a manner.

Specifically, if an individual were to enter more text for a region than can be displayed thereby, the text would have to be copy fitted to fit the region. Unfortunately, this may result in text that is either hard to read or that cannot be read at all when printed. This ultimately compromises the communication effectiveness for which the document layout was designed.

### SUMMARY OF THE INVENTION

In light of the forgoing, the present invention provides for a method for indicating a measure of a text fill copy fitting for a portion of text in a document. In this regard, the method comprises the steps of detecting a change in a text fill inputted into a text fill box in a computer system, measuring a length of the text fill, performing a comparison between the length of the text fill with at least one predetermined length threshold, and, indicating a compatibility of the text fill with an associated text portion of a document based on the comparison, the associated text portion incorporating the text fill.

The present invention also includes a computer program embodied in a computer readable medium for indicating a measure of a text fill copy fitting. In this regard, the computer program comprises logic for detecting a change in a text fill inputted into a text fill box displayed on a display device and logic for measuring a length of the text fill. The computer program also includes logic for performing a comparison between the length of the text fill with at least one predetermined length threshold and, logic for indicating a compatibility of the text fill with an associated text portion of a document based on the comparison, the associated text portion incorporating the text fill.

In addition, the present invention may also include a second method for indicating a measure of a text fill copy fitting. The second method comprises the steps of detecting a layout event in a digital document in a client device triggered by a user input, transmitting the digital document to a server via a network to perform a layout operation on the digital document upon an occurrence of the layout event, identifying a measure of a copy fitting of a text fill in a portion of the digital document by the layout operation in the server, and, generating an indication in the client for view by the user of the measure of the copy fitting of the text fill in the portion of the digital document.

The present invention also includes a second computer program embodied in the computer readable medium for indicating a measure of a text fill copy fitting. In this respect, the second computer program comprises logic for detecting a layout event in a digital document in a client device, and logic for transmitting the digital document to a server via a network to perform a layout operation on the digital document upon an occurrence of the layout event. The computer program further comprises logic for identifying a measure of a copy fitting of a text fill in a portion of the digital document by the layout operation in the server, and logic for generating an indication in the client for view by the user of the measure of the copy fitting of the text fill in the portion of the digital document.

The present invention provides several advantages including the fact that a user who enters text fill for inclusion into a document is informed of the degree of copy fitting necessary so that the text fill fits within the intended portion of the document.

Other features and advantages of the present invention will become apparent to a person with ordinary skill in the art in view of the following drawings and detailed description. It is intended that all such additional features and advantages be included herein within the scope of the present invention.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of a processing network according to an aspect of the present invention;

FIG. 2 is a drawing of a graphical user interface displayed on a client in the processing network of FIG. 1 based upon a web page downloaded from a server in the processing network;

FIG. 3 is a flow chart of a first sizing indication plug-in downloaded from a server to a client and executed in the client in the processing network of FIG. 1;

FIG. 4 is a flow chart of a second sizing indication plug-in downloaded from a server to a client and executed in the client in the processing network of FIG. 1; and

FIG. 5 is a flow chart of sizing indicator logic executed in the server of the processing network of FIG. 1.

### DETAILED DESCRIPTION OF THE INVENTION

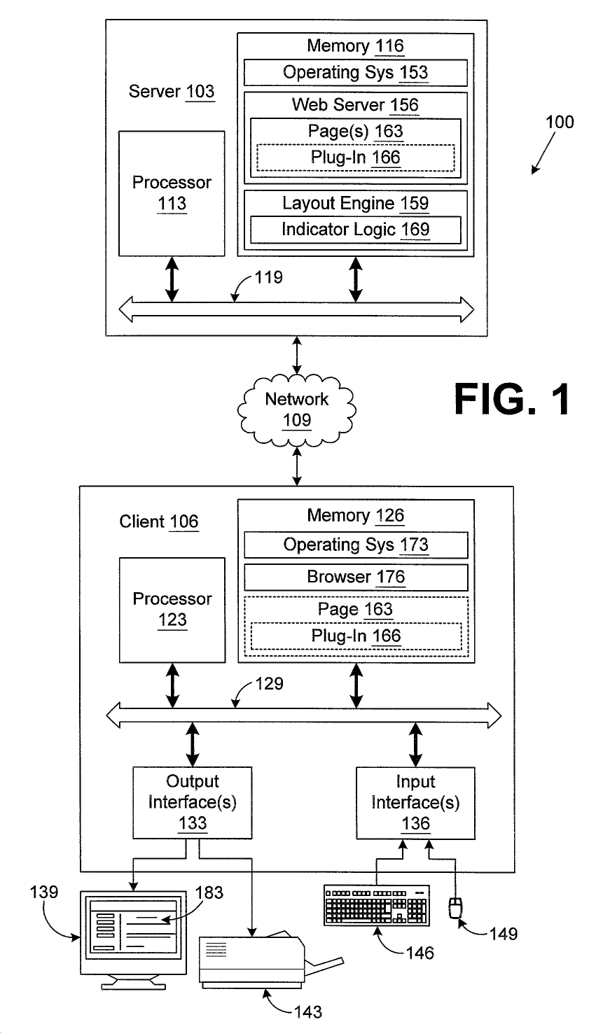

With respect to FIG. 1, shown is a document processing network 100 according to an aspect of the present invention. The document processing network 100 includes a server 103 and a client 106, both of which are coupled to a network 109. The server 103 may comprise, for example, a computer system or other apparatus with similar capability. In particular, the server 103 includes a processor circuit with a processor 113 and a memory 116, both of which are coupled to a local interface 119. The local interface 119 may comprise, for example, a data-bus with an accompanying control-bus as is generally known by those with ordinary skill in the art.

Various peripheral devices may be employed with the server 103. In particular, peripheral devices to obtain user input may include, for example, a keypad, touch pad, touch screen, microphone, scanner, mouse, joystick, or one or more push buttons, etc. Peripheral devices providing user output may include display devices, indicator lights, speakers, printers, etc. Specific display devices may be, for example, cathode ray tubes (CRT), a liquid crystal display screens, a gas plasma-based flat panel displays, light emitting diodes, etc.

The client 106 may comprise, for example, a computer system or other system with similar capability. In particular, the client 106 includes a processor circuit with a processor 123 and a memory 126, both of which are coupled to a local interface 129. The local interface 129 may be, for example, a data bus with an accompanying control bus as is generally known by those with ordinary skill in the art. The client 106 also includes various output interfaces 133 and input interfaces 136 through which the client 106 may be connected to various peripheral devices. Such peripheral devices may include a display device 139, a printer 143, a keyboard 146, and a mouse 149. Other peripheral devices that may be employed with the client 106 to receive various user input or to provide user output include those listed above with regard to the server 103.

The memories 116/126 may include both volatile and nonvolatile memory components. Volatile components are those that do not retain data values upon loss of power. Nonvolatile components are those that retain data upon a loss of power. Thus, the memories 116/126 may comprise, for example, random access memory (RAM), read-only memory (ROM), hard disk drives, floppy disks accessed via an associated floppy disk drive, compact disks accessed via a compact disk drive, magnetic tapes accessed via an appropriate tape drive, and/or other memory components, or a combination of any two or more of these memory components.

In addition, the processors 113/123 may represent multiple processors and the memories 116/126 may represent multiple memories that operate in parallel. In such a case, the local interfaces 119/129 may be an appropriate network that facilitates communication between any two of the multiple processors or between any processor and any of the memories, etc. The local interfaces 119/129 may facilitate memory to memory communication as well. The processors 113/123, memories 116/126, and local interfaces 119/129 may be electrical or optical in nature. Also, the memories 116/126 may be magnetic in nature.

In addition, the network 109 includes, for example, the Internet, wide area networks (WANs), local area networks, or other suitable networks, etc., or any combination of two or more such networks. The server 103 and the client 106 may be coupled to the network 109 to facilitate data communication to and from the network 109 in any one of a number of ways that are generally known by those of ordinary skill in the art. For example, the server 103 and/or the client 106 may be linked to the network 109 through various devices such as, for example, network cards, modems, or other such communications devices.

The server 103 also includes various software components that are stored on the memory 116 and executable by the processor 113. In particular, stored on the memory 116 is an operating system 153, a web server 156, and a layout engine 159. The web server 156 includes a number of pages 163. One or more of the pages 163 may include a plug-in 166 according to an aspect of the present invention. According to another aspect of the present invention, the layout engine 159 may include indicator logic 169 as will be discussed.

A client 106 also includes a number of software components that are stored on the memory 126 and executable by the processor 123. In particular, the client 106 includes an operating system 173 and a browser 176. By manipulating the browser 176, the pages 163 may be downloaded with or without the plug-in 166 from the server 103 having been transmitted by the web server 156 stored on the memory 116 of the server 103. Thus, the browser 176 and the web server 156 may operate according to the dictates of the world wide web protocol, for example, or other suitable protocol. In this sense, the pages 163 may be considered web pages, although other types of pages or data files may be employed. In one embodiment, the pages 163 may be created using hypertext mark-up language as is generally known by those with ordinary skill in the art. Alternatively, other programming languages may be employed to create the pages 163, including, extensible mark-up language (XML), C++, or other suitable computer language.

Both of the operating systems 153 and 173 are executed to control the allocation and usage of hardware resources in the server 103 and the client 106, respectively. Specifically, the operating systems 153 and 173 control the allocation and usage of the memories 116/126, processing time, and the peripheral devices as well as performing other functions. In this manner, the operating systems 153 and 173 serve as the foundation on which applications in the server 103 and the client 106 depend as is generally known by those with ordinary skill in the art.

In addition, the browser 176 in the client 106 may be executed by the processor 123 to interpret one or more pages 163 downloaded from the server 103. Based on the pages 163, the browser 176 generates corresponding graphical user interfaces (GUIs) 183 on the display device 139 that can be manipulated by the user of the client 106.

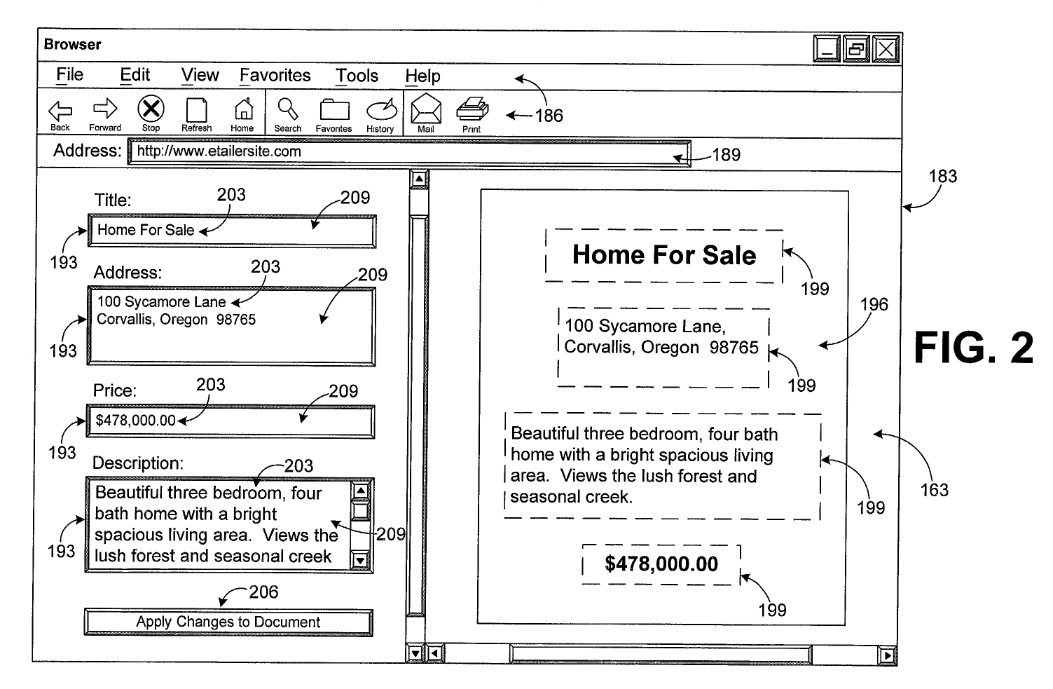

With reference to FIG. 2, shown is a graphical user interface (GUI) 183 according to an aspect of the present invention. The graphical user interface 183 includes various browser components 186 and an address box 189 that may be manipulated to access various web pages 163 (FIG. 1) on various servers 103 (FIG. 1) coupled to the network 109 (FIG. 1). Specifically, a user may enter a uniform resource locator (URL) in the address box 189 to access a specific page 163 located at a specific server 103.

The bottom portion of the GUI 183 displays the page 163 according to an aspect of the present invention. The page 163 includes a number of text fill boxes 193 in a left portion of the page 163. In a right portion of the page 163 is a digital document 196. The digital document 196 includes a number of text portions 199 according to an aspect of the present invention. Upon viewing the page 163 on the display device 139 (FIG. 1), the user may manipulate input devices such as the keyboard 146 (FIG. 1) and the mouse 149 (FIG. 1) to enter text or text fill 203 within each of the text fill boxes 193. The text fill 203 is included in the various text portions 199 of a resulting digital document 196 created using the layout engine 159 in the server 103. The user may then print out the digital document 196 for use in hardcopy form.

Each of the text fill boxes 193 is associated with a respective one of the text portions 199 of the digital document 196. The text fill 203 that is entered into each of the text fill boxes 193 is correspondingly displayed in the associated text portion 199 of the digital document 196. In one embodiment, the user enters the text fill 203 into the text fill boxes 193 and then manipulates the “apply changes” button 206 to cause the text fill 203 to be generated and displayed on the text portions 199 of the digital document 196. In another embodiment, the user need only to enter the text fill 203 into the respective text fill boxes 193 and the text automatically is displayed in the associated text portions 199 of the digital document 196 as will be discussed.

It is sometimes the case that a user may enter the text fill 203 into a respective text fill box 193 that ultimately requires a greater amount of space on the digital document 196 to be displayed then is afforded by the associated text portion 199. In such cases, the text fill 203 is copy fitted using copy fitting techniques to fit within the associated text portion 199 of the digital document 196. Such copy fitting may result in text that is not recognizable on the digital document 196 or text that is greatly reduced in size within the respective associated text portions 199 such that the effective communication of the ideas contained therein is lost. According to an aspect of the present invention, a color of the background 209 of each of the text fill boxes 193 is employed as an indicator. Specifically, the color informs a user of a degree of copy fitting that is to be performed to the text fill 203 in a particular text fill box 193 in order to fit within the associated text portion 199. Alternatively, a color of the text fill 203 itself may indicate the same circumstance.

In addition, other sorts of indicators that are associated with the individual text fill boxes 193 may be employed. Such indicators may include, for example, highlighting around the text fill boxes 193 or other highlighting, text underlining or other marking, text or background blinking, meters associated with the text fill boxes 193, graphical indicators of various shapes and sizes, and/or other indicators.

With the foregoing discussion in mind, references made to both FIGS. 1 and 2 to discuss the operation of the document processing network 100 according to the various embodiments of the present invention. In a first embodiment, a user manipulates the browser 176 to access a web page 163 on the server 103. The page 163 is downloaded to the client 106 and displayed by the browser 176 on the display device 139 as the GUI 183 depicted in FIG. 2. The page 163/GUI 183 provide a system that allows a user to create the digital document 196 for a specific purpose. As shown with respect to FIG. 2, the digital document 196 is a flyer to be posted advertising a home for sale. Note however, that the specific nature of the digital document 196 could encompass any type of document and is not limited to such a flyer as described herein, the flyer of FIG. 2 being shown as an example.

Once the page 163 has been downloaded, the user may enter the text fill 203 into the text fill boxes 193 with the keyboard 146 or other peripheral device to be displayed on the digital document 196. In one embodiment, the plug-in 166 is executed by the processor 123 to display a color in the background 209 of the respective text fill boxes 193 to indicate a measure of copy fitting to be applied to the text fill 203 so that it may fit within the associated text portions 199 of the digital document 196. When the user has entered all of the text fill 203 in the text fill boxes 193, the user may click on the “apply changes” button 206 and the digital document 196 along with the text fill 203 is transmitted to the server 103 and is supplied to the layout engine 159. The layout engine 159 generates the digital document 196 with the text fill 203 included within the respective text portions 199 of the digital document 196. Thereafter, the resulting digital document 196 is transmitted back to the client 106 to be viewed by the user on the display device 139.

In a second embodiment, the “apply changes” button 206 is not included in the page 163. Upon entering the text fill 203 into the text fill boxes 193, the text fill 203 is transmitted to the layout engine 159 along with other portions of the digital document 196 so that the layout engine 159 may perform a layout operation on the text fill 203 in real time to generate the digital document 196. The digital document 196 in its present state is then transmitted back to the client 106 and ultimately displayed on the display device 139 as part of the page 163. In this embodiment, the content that comprises the text fill 203 is transmitted to the server 103 in order to perform the layout operation using the layout engine 159 upon an occurrence of a layout event in the client 106 as the user inputs the text fill 203 into the text fill boxes 193. The layout event could be, for example, any change in the text fill 203 as entered by a user. Also, a layout event may occur periodically based upon a timer that is executed in the client 106.

According to this embodiment, the speed of the network 109 effects the time that it takes for the text fill 203 to be incorporated into the digital document 196 in the server 103 and transmitted back to the client 106 for display on the display device 139. For example, if the layout event occurs with each new letter that is typed into a respective one of the text fill boxes 193, then an extremely fast connection via the network 109 between the server 103 and the client 106 would be desirable. The fast speed is desirable so that the display of the text fill 203 in the text portions 199 of the digital document 196 keeps up with the entry of new text fill 203 in the text fill boxes 193 by the user.

Also, according to the second embodiment, the indicator logic 169 is executed by the processor 113 in the server 103 to determine a degree of copy fitting of the text fill 203 to fit within a respective text portion 199 of the digital document 196. This degree of copy fitting determined by the indicator logic 169 is recorded within the digital document 196 in a manner recognizable by the browser 176 of the client 106 to display a corresponding color in the background 209 of the respective text fill box 193. In this manner, the degree of copy fitting is indicated to the user. Alternatively, other indicators may be employed as well as was discuss with the first embodiment.

Note that many different colors within an indicator may be employed to indicate varying degrees of copy fitting that occurs to any one of the text fills 203 in the respective text fill boxes 193. For example, the color green may be employed to indicate that no copy fitting has occurred. The color yellow may be employed to indicate moderate copy fitting that is recognizable in the resulting digital document 196 and can still be read by individuals. A red color may be employed in a respective background 209 of a respective text fill box 193 when the text fill 203 for that text fill box 193 exceeds the threshold length above which the resulting text displayed in the digital document 196 is not recognizable or readable by the user.

Alternatively, rather than indicating the degree of copy fitting by changing the color of the backgrounds 209 of the respective text fill boxes 193, the color of the text fill 203 itself within the text fill boxes 193 may be altered in a similar fashion. Note that the degree of copy fitting may also be indicated with many more colors than green, yellow, and red as discussed above. Specifically, a unique color may be assigned for each of the predefined levels of copy fitting that may occur.

By manipulating the indicators as described above, a user may be made aware of the fact that they may have added too much text fill 203 to a respective one of the text fill boxes 193. As a result, a user is prevented from creating a digital document 196 that may not effectively communicate the information contained therein according to the original design of the digital document 196. Consequently, the user is informed of those situations where the text fill 203 should be reduced so as to fit effectively within the corresponding text portions 199 of the digital document 196.

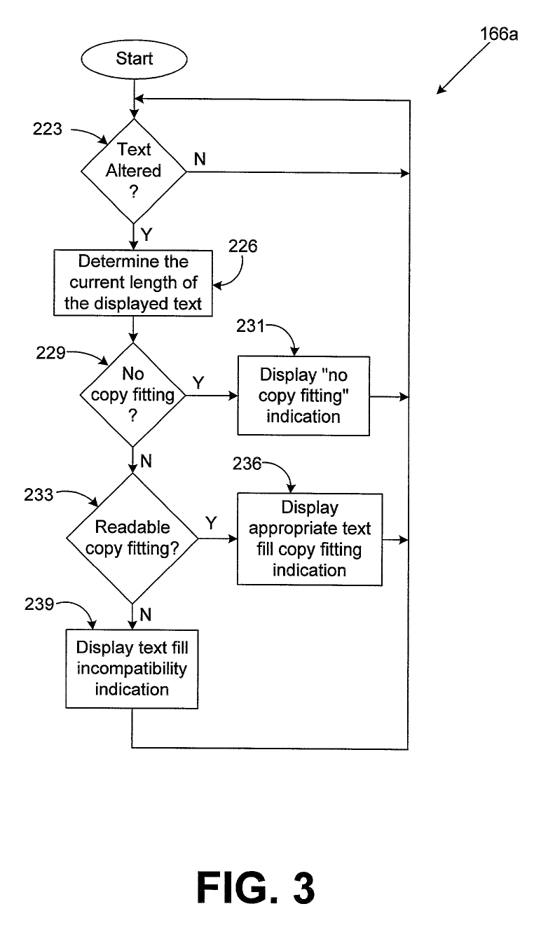

With reference to FIG. 3, shown is a flow chart of a first plug-in 166a according to an aspect of the present invention. The first plug-in 166a is executed by the processor 123 (FIG. 1) to generate an indication of the degree of text copy fitting to be applied to a specific text fill 203 (FIG. 2) as discussed previously. The indication may be a color to the backgrounds 209 (FIG. 2), the color of the text fill 203, or other indicator. Beginning with block 223, a first plug-in 166a determines whether any text fill 203 has been altered by either adding letters or deleting letters accordingly. If such is the case, then the first plug-in 166a moves to block 226 to determine the length of the text fill 203 that had been altered as detected in block 223.

Thereafter, in block 229, the length determined in block 226 is compared with a default length associated with the respective text fill box 193 (FIG. 2). If the length of the text fill 203 is less than the default length associated with the respective text fill box 193 (FIG. 2), then the first plug-in 166a moves to block 231 in which the indicator representing “no copy fitting necessary” is displayed in association with the respective text fill box 193. The first plug-in 166a then reverts back to block 223.

On the other hand, if copy fitting would be necessary as the length of the text fill 203 is greater than the default length associated with the respective text fill box 193, then the first plug-in 166a moves to block 233. In block 233, the length of the text fill 203 is compared with a second length threshold. The second length threshold indicates a point above which the copy fitting of the text fill 203 would not result in readable or otherwise recognizable text within the corresponding text portion 199. Assuming that the length of the text fill 203 is less than the second length threshold, then the first plug-in moves to block 236. Otherwise the first plug-in 166a moves to block 239.

In block 236, the first plug-in 166a compares the length of the text fill 203 with one or more threshold lengths to determine the degree of copy fitting that is necessary to fit the text fill 203 within the corresponding text portion 199. Note that the one or more text lengths are predetermined based upon known amounts of copy fitting for various lengths to fit within the corresponding text portion 199. Thereafter, an indicator color that corresponds to the lowest breached length threshold is identified and displayed in the background 209 of the respective text fill box 193 to indicate the level of copy fitting necessary to display the text fill 203 in the corresponding text portion 199. Thereafter, the first plug-in 166a reverts back to block 233.

Assuming that the first plug-in 166a has proceeded to block 239, then a text fill incompatibility indicator is generated in associated with the respective text fill 203. This indicator informs the user that the text fill 203 would have to be unrecognizably copy fitted using copy fitting techniques during the layout operation in the server 103 in order to fit within the corresponding text portion 199 of the digital document 196. Assuming the incompatibility indicator is a specific color, it is then displayed in the background 209 of the corresponding text fill box 193 or the respective text fill 203 may be displayed in such color, etc. Thereafter, the first plug-in 166 reverts back to block 223.

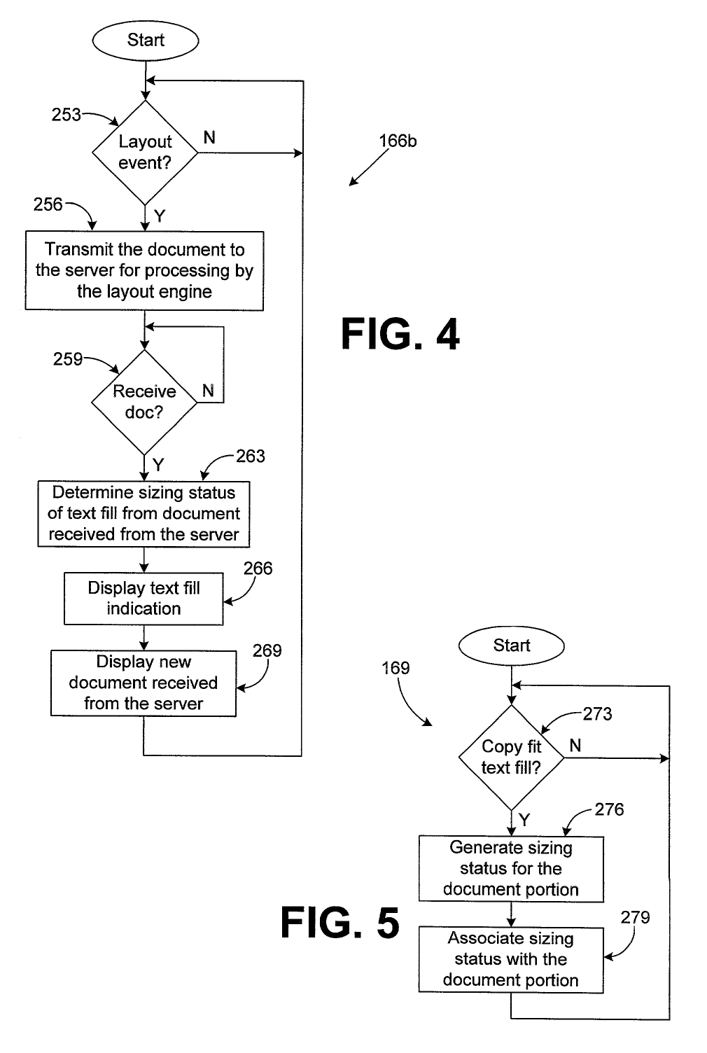

With reference to FIG. 4, shown is a flow chart of a second plug-in 166b according to an aspect of the present invention. The second plug-in is executed by the processor 123 (FIG. 1) of the client 106 (FIG. 1) upon an occurrence of a layout event to transmit the various portions of text fill 203 (FIG. 2) to be included in the digital document 196 (FIG. 2) by the layout engine 159 (FIG. 1). Beginning with block 253, the second plug-in 166b determines whether a layout event has occurred. In this respect, a layout event may be any alteration to a particular text fill 203 (FIG. 2) within one of the text fill boxes 209. Alternatively, the layout event may be a timeout of a timer that recycles periodically or other event. Assuming that a layout event has occurred, then the second plug-in 166b proceeds to block 256 in which the various portions of text fill 203 are transmitted to the server 103 (FIG. 1) for processing by the layout engine 159 (FIG. 1) to generate the corresponding digital document. Specifically, all of the text fill 203 is transmitted in association with the text fill portions 199 of the digital document 196 and the layout engine 159 generates the digital document 196 therefrom. Thereafter, the second plug-in 166b progresses to block 259 to wait for a reply from the server 103 that includes the digital document 196.

Once the digital document 196 has been received, the second plug-in 166b proceeds to block 263 in which the sizing status of each text fill 203 is determined from the digital document 196. The sizing status of each text fill 203 is associated with the respective text portions 199 of the digital document by the layout engine 159. Thereafter, in block 266 an sizing indication is displayed in association with the respective text fill boxes 193 to indicate the degree of copy fitting that the corresponding text fill 203 has undergone to fit within the respective text portions 199. Thereafter, in block 269 the digital document 196 is displayed in the graphical user interface 183 (FIG. 2). The second plug-in 166b then reverts back to block 253.

With reference to FIG. 5, shown is a flowchart of the indicator logic 169 that is associated with the layout engine 159 (FIG. 1) within the server 103 (FIG. 1). The indicator logic 169 is executed to associate a sizing status with each of the text portions 199 (FIG. 2) of the digital document 196 (FIG. 2) for reference by the client 106 (FIG. 1). Beginning with block 273, the indicator logic 169 determines whether any copy fitting has occurred to a particular text fill 203 (FIG. 2) in order to fit within an associated text portion 199. If such is the case, then the indicator logic 169 moves to block 276 in which a sizing status is generated for the particular text portion 199. Thereafter, in block 279 the sizing status is associated with the particular text portion 199 of the digital document 196. Then, the indicator logic 169 reverts back to block 273. The layout engine 159 then transmits the complete digital document 196 to the client 106 along with the associated sizing status for each of the text portions 199. As discussed above, the client 106 then displays the appropriate sizing indicator in association with the respective text fill box 209 to indicate to the user the degree of copy fitting that has occurred to the text fill 203 associated therewith in order to fit within the text fill box 199.

Although the plug-ins 166a/166b (FIGS. 4 and 5) and the indicator logic 169 of the present invention is embodied in software executed by general purpose hardware as discussed above, as an alternative the plug-ins 166a/166b and the indicator logic 169 may also be embodied in dedicated hardware or a combination of software/general purpose hardware and dedicated hardware. If embodied in dedicated hardware, the plug-ins 166a/166b and the indicator logic 169 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow charts of FIGS. 3, 4, and 5 show the architecture, functionality, and operation of an implementation of the plug-ins 166a/166b and the indicator logic 169. If embodied in software, each block may represent a module, segment, or portion of code that comprises one or more action statements in the form of executable instructions or declarations to implement the specified logical function(s). If embodied in hardware, each block may represent a circuit or a number of interconnected circuits to implement the specified logical function(s). Although the flow charts of FIGS. 3, 4, and 5 show a specific order of execution, it is understood that the order of execution may differ from that which is depicted. For example, the order of execution of two or more blocks may be scrambled relative to the order shown. Also, two or more blocks shown in succession in FIGS. 3, 4, and 5 may be executed concurrently or with partial concurrence. It is understood that all such variations are within the scope of the present invention. Also, the flow charts of FIGS. 3, 4, and 5 are relatively self-explanatory and are understood by those with ordinary skill in the art to the extent that software and/or hardware can be created by one with ordinary skill in the art to carry out the various logical functions as described herein.

Also, the plug-ins 166a/166b and the indicator logic 169 can be embodied in any computer-readable medium for use by or in connection with an instruction execution system such as a computer/processor based system or other system that can fetch or obtain the logic from the computer-readable medium and execute the instructions or action statements contained therein. In the context of this document, a “computer-readable medium” can be any medium that can contain, store, or maintain the plug-ins 166a/166b and the indicator logic 169 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

I/We claim:

1. A method for indicating a measure of a text fill copy fitting, comprising:
detecting a change in a text fill inputted into a text fill box in a computer system;
measuring a length of the text fill;
performing a comparison between the length of the text fill with at least one predetermined length threshold; and
indicating a compatibility of the text fill with an associated text portion of a document based on the comparison, the associated text portion incorporating the text fill.

2. The method of claim 1, wherein the step of performing the comparison further comprises:
providing a first length threshold in a memory of the computer system, the first length threshold marking a length of the text fill above which a copy fitting of the text fill is performed to fit within the associated text portion; and
performing the comparison between the length of the text fill and the first length threshold.

3. The method of claim 1, wherein the step of performing the comparison further comprises:
providing a second length threshold in a memory of the computer system, the second length threshold marking a length of the text fill above which the text fill can not be recognizably copy fitted to fit within the associated text portion; and
performing the comparison between the length of the text fill and the second length threshold.

4. The method of claim 2, wherein the step of indicating the compatibility of the text fill with the associated text portion of the document further comprises indicating that the length of the text fill is less than the first length threshold by displaying a first background color in the text fill box on a display device of the computer system.

5. The method of claim 2, wherein the step of indicating the compatibility of the text fill with the associated text portion of the document further comprises indicating that the length of the text fill has surpassed the first length threshold by displaying a second background color in the text fill box on a display device of the computer system.

6. The method of claim 3, wherein the step of indicating the compatibility of the text fill with the associated text portion of the document further comprises indicating that the length of the text fill has surpassed the second length threshold by displaying a third background color in the text fill box on a display device of the computer system.

7. A computer program embodied in a computer readable medium for indicating a measure of a text fill copy fitting, comprising:
at least one statement for detecting a change in a text fill inputted into a text fill box displayed on a display device;
at least one statement for measuring a length of the text fill;
at least one statement for performing a comparison between the length of the text fill with at least one predetermined length threshold; and
at least one statement for indicating a compatibility of the text fill with an associated text portion of a document based on the comparison, the associated text portion incorporating the text fill.

8. The computer program embodied in the computer readable medium of claim 7, wherein the at least one statement for performing the comparison further comprises:
at least one statement for providing a first length threshold marking a length of the text fill above which a copy fitting of the text fill is performed to fit within the associated text portion; and
at least one statement for performing the comparison between the length of the text fill and the first length threshold.

9. The computer program embodied in the computer readable medium of claim 7, wherein the at least one statement for performing the comparison further comprises:
at least one statement for providing a second length threshold marking a length of the text fill above which the text fill can not be recognizably copy fitted to fit within the associated text portion; and
at least one statement for performing the comparison between the length of the text fill and the second length threshold.

10. The computer program embodied in the computer readable medium of claim 8, wherein the at least one statement for indicating the compatibility of the text fill with the associated text portion of the document further comprises at least one statement for indicating that the length of the text fill is less than the first length threshold by displaying a first background color in the text fill box.

11. The computer program embodied in the computer readable medium of claim 8, wherein the at least one statement for indicating the compatibility of the text fill with the associated text portion of the document further comprises at least one statement for indicating that the length of the text fill has surpassed the first length threshold by displaying a second background color in the text fill box.

12. The computer program embodied in the computer readable medium of claim 9, wherein the at least one statement for indicating the compatibility of the text fill with the associated text portion of the document further comprises at least one statement for indicating that the length of the text fill has surpassed the second length threshold by displaying a third background color in the text fill box.

13. A method for indicating a measure of a text fill copy fitting, comprising:
detecting a layout event in a digital document in a client device triggered by a user input;
transmitting the digital document to a server via a network to perform a layout operation on the digital document upon an occurrence of the layout event;
identifying a measure of a copy fitting of a text fill in a portion of the digital document by the layout operation in the server; and
generating an indication in the client for view by the user of the measure of the copy fitting of the text fill in the portion of the digital document.

14. The method of claim 13, wherein the step of generating the indication in the client for view by the user of the measure of the copy fitting of the text fill in the portion of the digital document further comprises the step of generating a display of a color code on a display device of the client, the color code being associated with the measure of the copy fitting of the text fill.

15. The method of claim 14, wherein the step of generating the display of the color code on the display device of the client, the color code being associated with the measure of the copy fitting of the text fill further comprises the step of generating a first color code that is associated with the text fill, the first color code indicating that the text fill was not copy fitted during the layout operation in the server.

16. The method of claim 14, wherein the step of generating the display of the color code on the display device of the client, the color code being associated with the measure of the copy fitting of the text fill further comprises the step of generating a second color code that is associated with the text fill, the second color code indicating that the text fill was recognizably copy fitted during the layout operation in the server.

17. The method of claim 14, wherein the step of generating the display of the color code on the display device of the client, the color code being associated with the measure of the copy fitting of the text fill further comprises the step of generating a third color code that is associated with the text fill, the third color code indicating that the text fill was unrecognizably copy fitted during the layout operation in the server.

18. The method of claim 16, wherein the step of generating a second color code that is associated with the text fill, the second color code indicating that the text fill was recognizably copy fitted during the layout operation in the server further comprises the step of generating one of an array of second color codes, each of the second color codes indicating a predefined measure of a recognizable copy fitting of the text fill.

19. A computer program embodied in the computer readable medium for indicating a measure of a text fill copy fitting, comprising:
logic for detecting a layout event in a digital document in a client device;
logic for transmitting the digital document to a server via a network to perform a layout operation on the digital document upon an occurrence of the layout event;
logic for identifying a measure of a copy fitting of a text fill in a portion of the digital document by the layout operation in the server; and
logic for generating an indication in the client for view by the user of the measure of the copy fitting of the text fill in the portion of the digital document.

20. The computer program embodied in the computer readable medium of claim 19, wherein the logic for generating the indication in the client for view by the user of the measure of the copy fitting of the text fill in the portion of the digital document further comprises logic for generating a display of a color code on a display device of the client, the color code being associated with the measure of the copy fitting of the text fill.

21. The computer program embodied in the computer readable medium of claim 20, wherein the logic for generating the display of the color code on the display device of the client, the color code being associated with the measure of the copy fitting of the text fill further comprises logic for generating a first color code that is associated with the text fill, the first color code indicating that the text fill was not copy fitted during the layout operation in the server.

22. The computer program embodied in the computer readable medium of claim 20, wherein the logic for generating the display of the color code on the display device of the client, the color code being associated with the measure of the copy fitting of the text fill further comprises logic for generating a second color code that is associated with the text fill, the second color code indicating that the text fill was recognizably copy fitted during the layout operation in the server.

23. The computer program embodied in the computer readable medium of claim 20, wherein the logic for generating the display of the color code on the display device of the client, the color code being associated with the measure of the copy fitting of the text fill further comprises logic for generating a third color code that is associated with the text fill, the third color code indicating that the text fill was unrecognizably copy fitted during the layout operation in the server.

24. The computer program embodied in the computer readable medium of claim 22, wherein the logic for generating a second color code that is associated with the text fill, the second color code indicating that the text fill was recognizably copy fitted during the layout operation in the server further comprises logic for generating one of an array of second color codes, each of the second color codes indicating a predefined measure of a recognizable copy fitting of the text fill.
